(19) United States
(12) Patent Application Publication
(10) Pub. No.: US 2005/0084139 A1
(43) Pub. Date: Apr. 21, 2005

(54) Identity verification system with interoperable and interchangeable input devices

(75) Inventor: Wayne Kyle, Gauteng (ZA)

Correspondence Address: ELIZABETH R. HALL, 1722 MARYLAND STREET, HOUSTON, TX, 77006, US

(73) Assignee: BioCom, LLC, Houston, TX (US)

(21) Appl. No.: 10/974,356

(22) Filed: Oct. 27, 2004

Related U.S. Application Data
(63) Continuation-in-part of application No. 10/437,328, filed on May 13, 2003, now Pat. No. 6,853,739.

(51) Int. Cl. G06K 9/00

(52) U.S. Cl. 382/115

(57) ABSTRACT

The present invention is an interoperable biometrics system that utilizes one or more video communication control devices 32 and/or one or more digital data conversion devices 33 to allow multiple analogue 20 and/or digital 21 output biometric capture devices to communicate with a processing computer 25. The system further incorporates a routing software for addressing and naming the various hardware devices and software systems to enable interoperability between different makes and models and the biometrics capture and/or processing devices, their relevant communications software, and their relevant processing software and algorithms.

### CROSS REFERENCE TO RELATED APPLICATIONS

This application is a continuation in part of pending U.S. patent application Ser. No. 10/437,328 (Attorney Docket Number BICM-P002US), filed May 13, 2003 by inventor Wayne Kyle and entitled “Identity Verification System.”

### BACKGROUND OF THE INVENTION

1. Field of the Invention

The present invention relates generally to an identity verification system, and more particularly to an identity verification system that incorporates and interconnects one or more biometrics electronic recognition components.

2. Description of the Related Art

Recently there has been a global awareness of a need to increase the security of public places and transactions. It is particularly important to verify the identity of an individual and to verify that the individual is not a wanted terrorist or criminal. This need for increased security is especially true in sensitive areas such as airports, government buildings, border control points, sea ports, oil refineries, and the like. To implement this need for increased security, the identity verification systems used must be efficient and reliable. Such identity verification systems will typically rely on the verification of biometrics data.

Currently available security systems are exemplified by the security systems in place at a border crossing point. Multiple verification points may exist within any border crossing point. A verification point being defined herein as the point where the actual physical transaction takes place and where the input data is entered and where the biometrics samples are captured. The architecture of a typical biometrics verification point at a border crossing point is illustrated in FIG. 1.

Border crossing points generally use an analogue output biometrics capture device 20, such as a camera, interfaced to a local process computer 25 through a capture card to gather images for performing face or Iris recognition. In addition, a digital output biometrics capture device 21, such as an optical fingerprint sensor with a digital output format, is interfaced to the same local process computer 25 via an installed USB port. The optical fingerprint sensor is required to gather images of the individual's fingerprints for the purposes of performing fingerprint matching, either on the same local process computer or on another process computer in communication with that local process computer.

Existing system architectures that use a computer at each point of capture and verification are generally expensive and cannot be used in all environments. Additionally, it is often impractical to use a computer at every verification point where biometrics samples may need to be gathered. As an example, an access-control system at an airport may need to have such biometrics gathering and verification devices at many different points within the airport in order to verify the identity of persons who wish to pass through a doorway. It is not cost effective or logistically viable to install a computer at every doorway in the airport that may require such biometrics verification in order to verify the identity of the person who wishes to enter.

There exists a need to consolidate this process so that biometrics images and related data, whether in analogue or digital form, can be captured, compressed, and/or digitized by one or more non-computer based devices that can communicate with a single central processing unit via a computer network. The data communicated by this consolidated process must by usable for identifying an individual (i.e., a one-to-many match in a database of biometrics data to search for an identity) or verifying the identity of an individual by matching existing records of enrolled biometrics data linked to a unique identifier for such previously enrolled individual.

Furthermore, there exists a need to consolidate the gathering of multiple biometrics samples or data from multiple biometrics capture and/or processing devices of differing manufacturers based on differing biometrics recognition systems. Since it is a well-documented fact that no single biometrics technology is perfect, a combination of multiple biometrics technologies dramatically increases the overall reliability and performance of the identity verification system. In addition, interfaces to the various types of biometrics sensors/devices and the interfaces to the analogue or digital cameras need to be designed in such a manner as to allow for field interchangeability of these devices or cameras.

### SUMMARY OF THE INVENTION

The present invention includes either one or more video communication control devices and/or one or more digital data conversion devices that connect directly to at least one biometrics capture and/or processing device.

One aspect of the present invention is an identity recognition system comprising: a plurality of biometrics input devices, wherein each device captures an image or a data file representing a unique biometrics characteristic of an individual; a plurality of communication control devices, wherein one communication control device front-end prepares the image or the data file captured from one biometrics input device; a central processing computer for processing the front-end-prepared image or data file to determine the identity of the individual, and a hub for communicating information between the central processing computer and the communication control devices.

Another aspect of the present invention is an identity verification system comprising: (a) a processing computer; (b) an analogue output biometrics capture device; (c) a video communication control device in communication with the analogue output biometrics capture device; (d) a digital output biometrics capture device; (e) a digital data conversion device in communication with the digital output biometric capture device; and (f) an Ethernet hub/switch in communication with the video communication control device, the digital data conversion device, and the processing computer.

A further aspect of the present invention is a method for image capture and identity verification and/or identification comprising the steps of: (a) retrieving a biometrics image, or a set of biometrics images of an individual taken with an analogue output biometrics capture and/or processing device with a video communication control device; (b) converting the biometrics image(s) into a compressed or uncompressed digital image file; (c) converting the digital image file into a standard network protocol; (d) transmitting the digital image file to a central processing unit for image verification or identification, said central processing unit having installed application software capable of identifying the make and model of the biometrics capture and/or processing device used to capture the biometrics image(s) by referencing the IP (Internet Protocol) Address of the transmitting video communication control device, and capable of sending the digital image file or files to one or more relevant biometrics algorithm engine(s) residing on the central processing unit for processing, the results of which can be returned to an external application or system in the form of a positive or negative result. In the event of the digital image file or files being sent to more than one algorithm engine for the purposes of comparison or matching, and the results of said comparisons or matches being returned by each algorithm engine individually, the individual results may be combined through a mathematical fusion process in order to attain a higher degree of confidence in the returned result. This mathematical fusion process could be a simple rule based calculation that averages the scores returned by the individual algorithm engines, or it could be a complex mathematical algorithm that fuses the scores attained in a more advanced manner, taking other external factors into account such as demographic information of the person from whom the biometrics images originated, such as gender, race or nationality. Alternatively, the individual results could be returned to the external application or system where they may be combined by whatever method or used individually to make a decision pertaining to the identification or verification.

A similar aspect of the present invention is a method for biometrics data capture and identity verification and/or identification comprising the steps of: (a) retrieving a set of biometrics related data in processed or unprocessed form from a digital output biometrics capture and/or processing device with a digital data conversion device; (b) converting the received data from its original protocol to a standard network protocol; (d) transmitting the digital data to a central processing unit for biometrics verification or identification, said central processing unit having installed application software capable of identifying the make and model of the biometrics capture and/or processing device used to capture the biometrics data by referencing the IP (Internet Protocol) Address of the transmitting digital data conversion device, and capable of sending the digital data to one or more relevant biometrics algorithm engine(s) residing on the central processing unit for processing, the results of which can be returned to an external application or system in the form of a positive or negative result. In the event of the digital data being sent to more than one algorithm engine for the purposes of comparison or matching, and the results of said comparisons or matches being returned by each algorithm engine individually, the individual results may be combined through a mathematical fusion process in order to attain a higher degree of confidence in the returned result. This mathematical fusion process could be a simple rule based calculation that averages the scores returned by the individual algorithm engines, or it could be a complex mathematical algorithm that fuses the scores attained in a more advanced manner, taking other external factors into account such as demographic information of the person from whom the biometrics images originated, such as gender, race or nationality. Alternatively, the individual results could be returned to the external application or system where they may be combined by whatever method or used individually to make a decision pertaining to the identification or verification.

Yet another aspect of the present invention is a biometrics based method for Identifying, or verifying the identity of an individual, the method comprising the steps of: (a) Accepting a request for biometrics identification or verification from an external third-party system such as an access control system, such request being transmitted via software communications protocols from the external third-party system to the central processing unit over an Ethernet network, and containing within such request both a unique identifier linked to the identity of the person who has requested access to a building, and a location identifier identifying which biometrics capture and/or processing device needs to be activated in order to perform the identity verification; (b) processing such request by: (1) retrieving an image or set of images in digital image file form, or, retrieving a set of digital data from the relevant biometrics capture and/or processing device or devices over a computer network via the Video communication control device (in the event of an analogue output device), or via the digital data conversion engine (in the event of a digital output device), as identified by the location identifier; (2) sending such image or images, or digital data, to the relevant biometrics processing algorithm engine(s), such engine(s) being identified by the application residing on the central processing unit; (3) retrieving the results of such processing from the algorithm engine(s) in the form of a biometrics template (if not previously already created by the biometrics capture and/or processing device); (4) retrieving the previously stored templates linked to that person's identifier from the database; (5) sending the previously stored template and the newly acquired template to the relevant verification algorithm engine(s) for comparison and matching; (6) retrieving such results from the algorithm engine(s); and (7) transmitting such results back to the requesting third-party system over a computer network.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic representation of traditional connection methods for biometrics capture and/or processing devices;

FIG. 2 is a schematic representation of connection methods for biometrics capture and/or processing devices using the communication control device described in U.S. Pat. No. 6,725,383;

FIG. 3 is a representation of connection methods for biometrics capture and/or processing devices using the present invention; and

FIG. 4 is a schematic representation of a multi-biometrics capture and/or processing device.

### DESCRIPTION OF THE PREFERRED EMBODIMENTS

The present invention relates generally to a system and method used to facilitate interoperability between a broad range of biometrics capture and/or processing devices.

Existing biometrics architectures utilize a process computer or similar device for capturing images and data from biometrics capture and/or processing devices. The biometrics capture and/or processing devices generally fall into two basic types of devices, analogue output devices and digital output devices.

Analogue output biometrics capture and/or processing devices 20 capture image based biometrics information from an individual and output the captured image in an analogue image signal format. Examples of such devices include analogue or digital cameras that may be used for face or iris recognition (NTSC/PAL), optical fingerprint sensors, optical hand-geometry readers or similar devices that have an output in the form of an analogue signal.

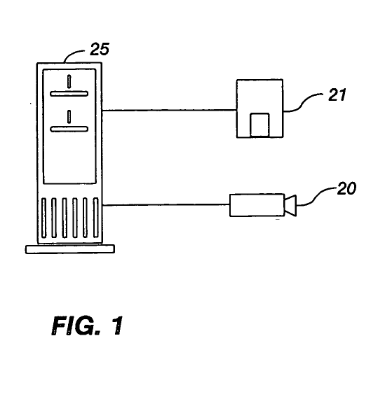

As illustrated in FIG. 1, analogue output devices are generally connected to the local process computer or similar device via installed video or image capture cards, also referred to as frame grabber cards, USB ports, firewire ports, serial ports, parallel ports and/or other proprietary connection mechanisms that will allow for an image to be retrieved out of a video stream by software residing on the local process computer.

Once the software residing on the local process computer 25 captures an image, the system relies on the processing software that resides on the local process computer 25 to process the images so that they can be “fed” into the biometrics software system used for identification and/or identity verification. For example, face recognition systems use various algorithms for face recognition comparison, face finding, and template creation and matching, while optical fingerprint systems use various algorithms for feature extraction, feature mapping, image enhancement and template creation.

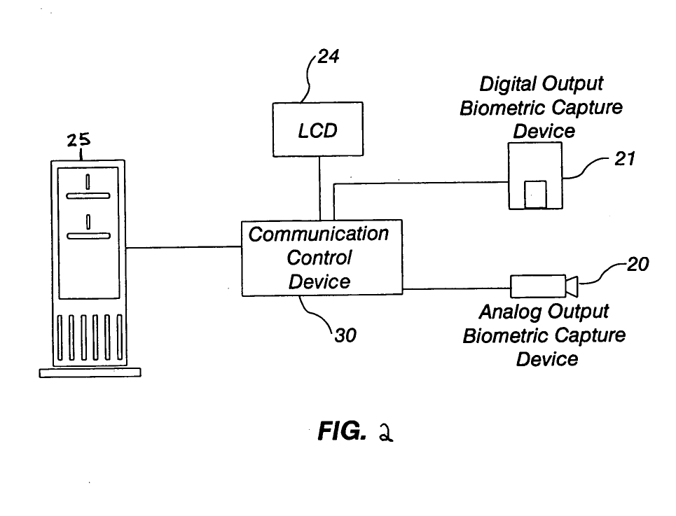

Alternatively, one or more analogue output devices may interface to a communication control device as described in U.S. Pat. No. 6,725,383 entitled “Data and Image Capture, Compression and Verification System” by inventor Wayne Kyle and U.S. patent application Ser. No. 10/437,328 entitled “Identity Verification System” by inventor Wayne Kyle as illustrated in FIG. 2. The analogue output devices 20 interface with the described communication control device 30 via a composite video input. The communication control device 30 (rather than the hardware and software of a local computer) captures and extracts images from the analogue video or image signal, converts the images to a digital format, and transmits the digital images to a local or remote processing computer via common network protocols where the images can be further processed.

In contrast to analogue output devices, digital output biometrics capture devices 21 perform some or all of the biometrics processing inside of the biometrics capture device. Since the digital output devices output all data in a digital format, digital output devices 21 cannot interface with a computer or other processing device via a video processing card, but rather require a digital interface via mechanisms that will allow digital data to transfer between the device 21 and the processing computer 25. Digital output biometrics capture devices 21 are connected via installed USB ports, serial ports, parallel ports, firewire ports or other proprietary connection mechanisms. However, the number of digital output devices 21 connected to the computer 25 is typically limited to the number of available ports of the relevant type.

One can get around this limitation by connecting multiple digital output biometrics capture devices 21 of the same make and model on a single serial port with the use of an RS485 protocol. It should be noted that an RS485 to RS232 converter is required to convert the protocol that is used by the serial port on the processing computer 25 (RS232) to the protocol that is used by the digital output biometrics capture devices 21 (RS485). Without this converter, the digital output biometrics capture processing devices 21 cannot communicate with the processing computer.

As illustrated in FIG. 1, one or more digital output devices are generally interfaced into a process computer and some or all of the data output from the device is sent to a processing computer 25 for full, partial or additional processing by the software systems and/or algorithms residing on the process computer. The processed data is used for identification and/or identity verification of an individual, or for insertion into a database residing on that process computer or another computer in communication with that process computer.

Alternatively, the digital output devices 21 may interface to the communication control device described in U.S. Pat. No. 6,725,383 entitled “Data and Image Capture, Compression and Verification System” by inventor Wayne Kyle and U.S. patent application Ser. No. 10/437,328 entitled “Identity Verification System” by inventor Wayne Kyle as illustrated in FIG. 2. When using the preferred embodiment of the communication control device 30, two digital output devices 21 can be interfaced to one communication control device 30 via one installed serial port using a RS232 protocol, or via one installed parallel port using an RS485 protocol. The communication control device converts the RS232 or RS485 data into a common network protocol format such as TCP/IP and transmits this data to a processing computer 25 where the data can be further processed.

Referring now in more detail to FIG. 2, the communication control device 30 described above is connected to an analogue output biometrics capture device 20 such as a camera, a digital output biometrics capture device 21 such as a fingerprint sensor, and a Liquid Crystal Display (LCD) 24. The analogue output biometrics capture device 20 is interfaced to the communication control device 30 via one of the composite video inputs located on that device. The digital output biometrics capture device 21 is connected to the communication control device 30 via the installed serial port located on that device. The LCD 24 is connected to the second serial port via an installed RS232 to RS485 converter located within the communication control device 30.

The preferred embodiment of the communication control device 30 described in U.S. Pat. No. 6,725,383 entitled “Data and Image Capture, Compression and Verification System” by inventor Wayne Kyle accommodates up to four analogue output biometrics capture devices 20 but is limited to a maximum of two digital output biometrics capture devices 21, or other digital output devices such as an LCD or card reader. Thus, if the biometrics system required the use of a card reader for data input, an LCD for user feedback, and a digital output biometrics capture device 21, then the communication control device 30 would not be suitable, since that communication control device 30 typically has only two installed digital input ports available.

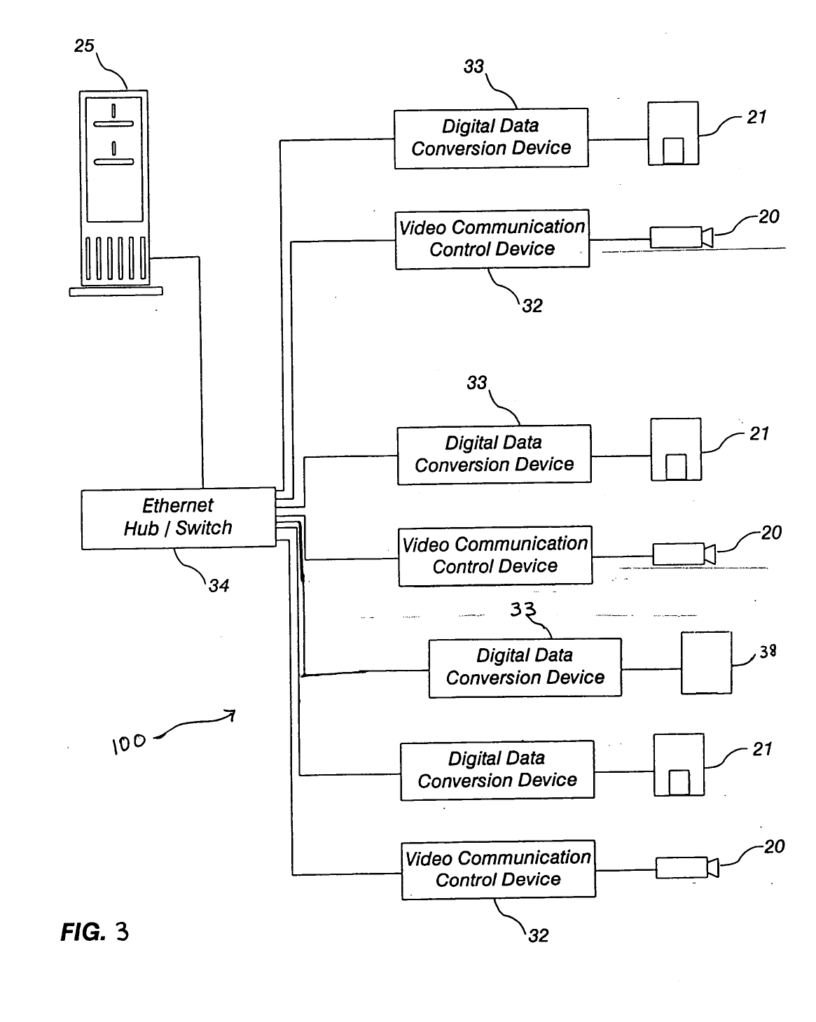

FIG. 3 shows the elements of a preferred embodiment of the identity verification system 100 of the present invention. The main components of the system 100 are: one or more analogue output biometrics capture devices 20, a video communication control device 32 in communication with each analogue output biometrics capture device 20, one or more digital output biometrics capture devices 21, a digital data conversion device 33 in communication with each digital output biometrics capture device 21, an Ethernet hub/switch 34, and a central processing computer (“CPC”) 25.

The present invention connects a processing computer 25 or computer network to a number of analogue output biometrics capture devices 20 and to a number of digital output biometrics capture devices 21. The present invention also facilitates the installation of various types of devices from different manufacturers, as well as the replacement of one device with another.

As illustrated in FIG. 3, each analogue output biometrics capture device 20 is connected to a video communication device 32. The analogue output biometrics capture devices 20 interface with the video communication device 32 through an analogue video input located on the video communication control device. Single-input commercially available video servers such as those available from Axis Communications of Lund, Sweden (model number 241S or equivalent) are used as the video communication control device for interfacing with analogue output biometrics capture devices 20.

The video communication control device 32 will receive or request a video stream or video signal from an analogue output biometrics capture and/or processing device and extract images from that stream or signal upon request from the software systems residing on a central processing computer 25.

The video communication control device 32 includes a camera server or video server having a video engine in communication with at least one analogue output biometrics capture and/or processing device. The video engine captures an image frame, or set of image frames out of a video feed coming from a camera or biometrics imaging device and converts the image frame(s) into compressed or uncompressed digital image file(s). In addition, the video communication control device 32 has a transmitting engine that formats the image file(s) into a protocol suitable for transmission over a computer network.

Similarly, each digital output biometrics capture device 21 is connected to a digital data conversion device 33. The digital output biometrics capture device 21 interfaces to the digital data conversion device 33 via a DB9 port or screw connector terminal located on the digital data conversion device 33. The digital data conversion device 33 can convert USB, RS232, RS485, RS422 or any similar commonly used protocol to the network based protocol required for operation of the system. Commercially available serial device servers, such as those available from Lantronix of Irvine, Calif., U.S.A. are used in the digital data conversion aspect of the present invention for interfacing with digital output biometrics capture devices 21. The digital data conversion device will receive or request digital data from the digital output biometrics capture and/or processing device upon request from the software systems residing on a central processing computer 25.

The digital data conversion device 33 comprises a serial server with a communications engine, a conversion engine, and a transmitting engine. The communications engine communicates with the digital output biometrics capture and/or processing device 21, the conversion engine converts the data received from the biometrics capture and/or processing device 21 from whatever format was used by that device to a network based protocol, and the transmitting engine enables the converted data to be transmitted over a computer network.

The video communication control devices 32 and digital data conversion devices 33 are used to front-end prepare (e.g., capture, compress, digitize, and convert to a common TCP/IP or IP-based protocol) photographic image frames and biometrics-related data. As part of the front-end preparation of the images and data, the video communication control devices 32 and digital data conversion devices 33 incorporate a location identifier (IP address) with the images and data to identify the biometrics capture device from which the images or data originated and any related information concerning the device to facilitate the proper interaction and routing of the communicated data to the proper biometrics processing system on the processing computer 25. The front-end prepared images and data are then communicated to a remote CPC 25 via an Ethernet hub/switch 34.

The Ethernet hub/switch is in communication with both the biometrics capture devices and at least one processing computer 25 via a computer network. Suitable Ethernet hub/switches 34 are the multi-port hub/switches such as the 4, 8 or 16 port hub/switches that are commercially available from D-Link Systems, Inc. of Fountain Valley, Calif., United States of America. The communications between the video communications control device(s) 32 and/or the digital data conversion device(s) 33 and the processing computer(s) 25 is via a standard network protocol, including without limitation, a TCP/IP, HTTP, UDP, or ARP protocol. The elimination of the need for a local process computer interfaced to each biometrics capture and/or processing device results in a reduction of possible points-of-failure, and also results in a reduction in capital expenditure, ongoing maintenance, and increases the stability of the system.

In addition, an optional visual output device 38, such as liquid crystal displays (LCD), TFT monitors, touch-screen displays and other devices, may be provided to provide interactive feedback on the status and/or outcome of the identity verification to the operator and/or individual who is verifying. The optional visual output device 38 is connected to the Ethernet hub/switch 34 via a digital data conversion device 33.

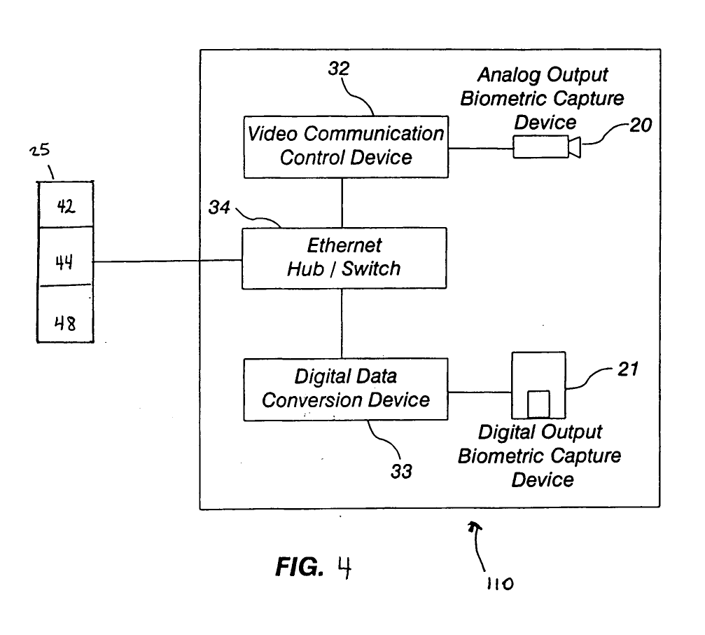

The CPC or processing computer 25 can (but does not have to) reside in close proximity to the biometrics capture and/or processing devices. In addition, the processing computer 25 may communicate with a computer network of one or more servers, or additional computers, via a wired or a wireless connection. The processing computer 25 and the other components of the computer network communicate via any standard computer network (LAN or WAN), medium copper cable, fiber optic cable, laser, radio frequency and the like. The term processing computer 25 as used herein will apply interchangeably to the process computer 25 and the processing computer network (i.e., the processing computer as well any servers and/or other computers in communication with the processing computer). The processing computer 25 includes one or more biometrics processing systems 42 including processing software and proprietary algorithms, one or more reference databases 44, and one or more device drivers 48 as illustrated in FIG. 4 and described in more detail below.

The processing computer 25 further processes the front-end-prepared images and/or data received from the Ethernet hub/switch 34 using a process for biometrics-comparison and/or biometric-template creation/matching (hereinafter referred to as “the biometrics processing system” 42. The biometrics processing system 42 includes at least one biometrics algorithm engine and system typically provided by the vendor of the biometrics processing system. Usually, one or more CPCs will incorporate more than one such biometric processing system 42. The purpose of such biometrics processing systems 42 and their associated algorithms is to process the front-end prepared images and/or data sent to the processing computer 25 and to use commonly accepted and often patented algorithms to identify and plot unique characteristics of the images and/or data and to perform template creation and/or matching for the purposes of biometrics verification and/or identification.

Such biometrics processing systems 42 can process, but are not limited to processing, active and passive face, finger, voice, signature, hand, iris and other physiological and behavioral characteristic images and data for the purpose of biometrics verification or identification. Commercially available examples of such devices and algorithms include: fingerprint sensors and algorithms from Secugen (Milpitas, Calif.), Identix (Minnetonka, Minn.) and Bioscrypt (Van Nuys, Calif.); face recognition algorithms from Identix, Visage (Littleton, Mass.) and Cognitec (Dresden, Germany); iris recognition imaging systems from LG (Engelwood Cliffs, N.J.) and Iridian Technologies (Moorestown, N.J.); hand recognition readers and algorithms from Biomet (Morat, Switzerland) and Recognition Systems of (Campbell, Calif.).

FIG. 4 is a schematic illustration of a multi-biometrics capture and/or processing device 110 where more than one analogue 20 and/or digital output 21 biometrics capture devices are interconnected via an Ethernet switch/hub 34 and placed within the same enclosure or in close proximity to one another so that more than one biometrics aspect of a person is acquired at the same time. The multi-biometrics capture and/or processing device 110 of the present invention can combine any two or more types of biometrics capture devices within a single modular device. Typically, the multi-biometrics capture and/or processing device 110 also includes a visual output device 38.

The purpose of performing more than one biometrics verification or identification on the same person at the same time is to increase the overall reliability and accuracy of the biometrics system as a whole. While one person's face may look enough like another person's face to give a false positive result in a face-recognition based biometrics system, it is highly unlikely that two individuals have both faces and fingerprints that so resemble each other as to give a false positive on both biometrics systems. Therefore, acquiring and combining the results from at least two biometrics systems (e.g., face-based and fingerprint-based systems) prior to making a final decision, vastly improves the accuracy of the final determination.

All biometrics systems benefit from this multi-layered approach to identification. This multi-layered or combination process, typically referred to as layering or fusion, diminishes the probability of making a mistake by allowing an imposter access, or by denying access to the true owner of an identity. There are many different ways in which this principle can be applied to a biometrics system. In its simplest form, the combination process may just require that two biometrics systems (e.g., a face recognition process and a fingerprint recognition process) both submit positive results within their individual configured parameters.

Alternatively, the individual results may be combined through a mathematical fusion process in order to attain a higher degree of confidence in the returned result. This mathematical fusion process could be a simple rule based calculation that averages the scores returned by the individual algorithm engines, or the results of each biometrics system could be individually submitted to an external algorithm that will apply a mathematical process or derivation designed to fit the two individual results within some type of standard curve before making a final determination. There are a number of complex mathematical algorithms that fuse the scores attained in a more advanced manner. For example, certain biometrics systems were developed and designed for particular populations and the results from such biometrics systems may be differentially weighted for certain external factors such as gender, race or nationality.

In addition, the individual results of the biometrics processing systems can be returned to an external system where security personnel can combine the results by any selected method or used the individual results to make a decision pertaining to the identification or verification.

The purpose of the multi-biometrics capture and/or processing device 110 is to acquire multiple biometrics traits from an individual in the quickest, least obtrusive and most comfortable manner possible. Hence, it sometimes becomes necessary to design a single enclosure that is conducive to such an acquisition process. The ergonomics of such a device are of particular importance so that the capture process becomes intuitive and simple.

The multi-biometrics capture and/or processing device 110 of the present invention utilizes a modular approach to provide increased flexibility to biometrics data gathering. The multi-biometrics device 110 links more than one analogue 20 and/or digital 21 output biometrics capture and/or processing devices to a computer network by connecting each device to the required video communication control device 32 or digital data conversion device 33 to digitize and process the data gathered before transmitting that data to the computer network via an Ethernet switch/hub 34. Thus, the multi-biometrics device 110 allows maximum flexibility in the selection of different types of biometrics capture devices as it can be constructed with any analogue and/or digital output devices of any make or model that use any type of biometrics analysis system. This is particularly important, since there are numerous different types of biometrics capture and/or processing devices that come in various shapes and sizes.

When computers were in their early development stages, each computer manufacturer made keyboards and mice that would only function on their brand of computer. Similarly, each manufacturer of biometrics devices has developed proprietary software designed to communicate and function with a single device or a range of devices made by that manufacturer, and not with any devices made by any other manufacturer.

The current use of a processing computer directly connected to each biometrics capture and/or processing device complicates the implementation of biometrics in identify verification since biometrics capture devices must be distributed throughout a building or facilities and are often housed in environmentally harsh environments where computers would not be able to function, or where the use of computers would render the implementation cost-prohibitive or impractical. To successfully implement biometrics-based identity verification systems, the employed biometrics systems must provide interoperability between biometrics capture and/or processing devices from differing manufacturers and for varying makes and models of devices. Only when biometrics systems exhibit true interoperability can the selected biometrics-based identity verification system employ the best combination of makes and models of biometrics capture and/or processing devices, and, of biometrics processing algorithms, to maximize the overall performance of the total biometrics system.

Two major problems have hampered the implementation of interoperable biometrics identity verification systems. The first problem is that biometrics capture and/or processing devices often use a variety of different communications mediums. Some devices use RS232 protocols, while others use RS485, TTL, analogue video or IP (Internet Protocol) based protocols for communication with one or more processing computers. The second problem is that the biometrics capture and/or processing devices from differing manufacturers will almost always use a completely different set of commands that are always packaged differently within the base protocol, even if the communications medium is the same.

The present invention consolidates these protocols and converts them all to a single common protocol to facilitate interoperability. This is achieved by using a combination of video communication control devices 32 and digital data conversion devices 33 as previously shown in FIG. 4 to convert the outputs of both analogue output 20 and digital output 21 biometrics capture and/or processing devices into a single common protocol format that can be transmitted over a common communications medium. The preferred format of the present invention being a TCP/IP or similar IP based protocol that can be transmitted via a common Ethernet based computer network.

In contrast to the communication control device 30, shown in FIG. 2 and described in described in U.S. Pat. No. 6,725,383 entitled “Data and Image Capture, Compression and Verification System” by inventor Wayne Kyle and U.S. patent application Ser. No. 10/437,328 entitled “Identity Verification System” by inventor Wayne Kyle, the present invention separates the functions of analog and digital interfacing into corresponding video communication control devices 32 and digital data conversion devices 33 rather than a single device. Although the communication control device 30 permits its connection to multiple analogue and digital output devices and communication of the data from those devices with a processing computer 25, the communication control device 30 requires that a prospective user purchase an entire communication control device for each physical location where one or more biometric capture and/or processing devices may reside. Should a user wish to utilize only one such device, he is still required to utilize a complete communication control device 30. Furthermore, preferred embodiments of the communication control device 30 only allow a maximum of two digital output devices (one RS232 protocol based device and one RS485 protocol based device) to be connected.

The multi-biometrics capture and/or processing device 110 of the present invention expands the functionality and improves the scalability of the overall identity verification system by separating the analogue data capture and processing and the digital data processing. By adding a specific video communication control device 32 for a specific analog output biometric capture device 20 and a specific digital data conversion device 33 for a specific digital output biometric capture device 21, the multi-biometrics capture and/or processing device 110 is constructed specifically for however many makes and models of analogue or digital output biometric capture devices that a user selects.

The multi-biometrics device 110 allows a user to purchase a substantially lower cost device should he wish to only process either digital and/or analog data, but not both simultaneously, at the same location. It will furthermore offer the user the ability to implement more than two digital output devices at the same location by simply adding single use digital data conversion devices to the location as required. This approach offers a further advantage in that only a relatively low cost device will require replacement should it become faulty at any given location where more than one biometrics capture and/or processing devices are in use, whereas in the case of the communication control device 30, the entire device would have to be replaced should any one of the analog or digital input ports become faulty. Furthermore, while such communication control device 30 is being replaced, the other biometrics capture and/or processing devices that were linked to the communication control device 30 will not be able to function. Thus, the downtime in the communication control device 30 leads to an outage of that identity verification system with unacceptable side effects. Such side effects include, but are not limited to, an increase in processing time (for example at a border crossing point), the inability to access a facility (in the example of an access control system), or an erroneous access permission being granted to a threat individual such as a terrorist (in the example of an airport or passport control access system).

In addition, the separation of the analogue and digital output devices decreases the physical footprint of the overall device, which in turn leads to a decrease in real estate required for the communication control/conversion devices. This is of particular importance to biometric related immigration and passport control projects where counter space in airports at immigration control points is extremely limited.

While the video communication control devices 32 and digital data conversion devices 33 facilitate common protocols and allow for various different types, makes and models of biometrics capture and/or processing devices to communicate over a common communications network, they do not, on their own, link the relevant software algorithms and biometrics processing systems 42 on the processing computer 25 to the relevant biometrics capture and/or processing devices. Each-device requires a specific command set to be used to communicate with the software associated with that device that resides on the processing computer 25. Because of the numerous different types, makes and models of biometrics capture and/or processing devices that may be connected to the common Ethernet hub/switch 34 and the processing computer 25, the present invention contemplates that at least one biometrics processing system 42 will reside of the processing computer 25 for each make and model of biometrics capture device to be used.

For example, a digital output fingerprint device such as the one made by Bioscrypt, Inc. of Canada will require the relevant associated software made by that same company to be loaded on the processing computer before it can function. That software will generally send various commands in a proprietary format, but packaged as a known protocol (such as RS232 or RS485), in order to enable the fingerprint device to perform various biometrics-based functions such as the capture and comparison of fingerprint data.

The present invention requires software systems that will convert individual manufacturer's proprietary command sets from the protocol used by the proprietary software supplied by the vendor of the device to a common IP based protocol such as TCP/IP. Unfortunately, this is not often achieved using the Software Development Kits (SDK's) supplied by the vendors, since those SDK's most often assume that the vendor devices are connected to the computer through the originally intended format (such as RS232).

Since the present invention requires that all communication between the biometrics capture device and the processing computer uses a TCP/IP, or another similar IP based protocol, all commands and communication streams will need to be repackaged in the relevant IP based protocol format. This repackaging is achieved by obtaining the relevant protocol specification for each biometrics capture device and converting those protocol specifications into an IP based protocol format so that communications can occur with the biometrics capture and/or processing device via the video communication control device or via the digital data conversion device, as the case may be. This process is similar to the process used for communication between computers and computer peripherals, such as keyboards and mice, commonly known as “writing device drivers.” The “device driver 48” for each biometrics software system is then loaded onto the processing computer 25, so that the biometrics processing system 42 with its associated algorithms and databases 44 residing on the processing computer can communicate with the biometrics capture and/or processing device that is in communication with the processing computer 25.

Once selected device drivers 48 are installed on the processing computer 25, the present invention uses an additional routing software system to specify the specific device driver and the specific vendor based biometrics processing system 42 needed to interface with the make and model of biometrics capture and/or processing device selected for use. This additional routing software resides in the video communication control device 32 and/or the digital data conversion device 33 and adds the location identifier (IP address) described above.

The routing software is configured to facilitate flexibility and interoperability between the biometrics capture and/or processing devices and a computer network. Most biometrics capture and/or processing devices require routing software to ensure proper communication between the software residing on the processing computer 25 and the biometrics capture and/or processing device. The routing software links: a) the make and model of the biometrics capture and/or processing device; b) the IP address of the video communication control device and/or digital data conversion device connected to the biometrics capture and/or processing device; c) the name and stored location of the device driver for the relevant biometrics capture and/or processing device; and d) the name and stored location of the relevant software systems required for the operation of the specific vendor biometrics capture and/or processing device such as algorithms and associated biometrics processing systems 42. For example, the routing software would associate data from an Identix V20 biometrics capture device available from Identix (Minnetonka, Minn.) with its IP address (192.168.0.100), its driver location (C:\Biocom\Drivers\V20.drv), and location of the biometrics processing system for that capture device (C:\Identix\V20.dll).

The resulting configuration data is then stored in the registry of the processing computer 25 or, preferably, the configuration data is stored in a database so that multiple processing computers in communication with one another can all access the data without the need to replicate that data on each of the processing computers.

Operation of the Identity Verification System

The present method includes a method for identity verification and/or identification comprising the steps of: (a) retrieving a biometrics image, or a set of biometrics images of an individual taken with an analogue output biometrics capture and/or processing device 20 in communication with a video communication control device 32, or biometrics data taken from an individual with a digital output biometrics capture and/or processing deice 21 in communication with a digital data conversion device 33; (b) converting the biometrics image or data file(s) into a compressed or uncompressed digital file; (c) converting the digital file into a standard network protocol; and (d) transmitting the digital file to a central processing unit 25 for identity verification. One or more biometrics processing systems 42, containing both the processing software and the algorithm(s) necessary to process the biometrics data acquired from a biometrics capture device, is installed on the central processing unit 25. The processing computer 25 also has application software capable of identifying the make and model of the biometrics capture and/or processing device used to capture the biometrics image(s) or data by referencing the IP (Internet Protocol) address of the transmitting video communication control device 32 or the digital data conversion device 33, and capable of sending the digitalized file or files to one or more relevant biometrics algorithm engine(s) residing on the central processing unit for processing. The results of the biometrics processing are returned to an external application or system in the form of a positive or negative identity verification. If a digital file or files are processed by more than one biometrics processing system 42 and algorithm engine for the comparison or matching of the acquired digital data with data existing in a referenced database 44, each biometrics processing system 42 and/or algorithm engine will return its results of the comparisons or matches performed.

The individual results may be combined through a mathematical fusion process in order to attain a higher degree of confidence in the returned result. This mathematical fusion process could be a simple rule based calculation that averages the scores returned by the individual algorithm engines, or it could be a complex mathematical algorithm that fuses the scores attained in a more advanced manner, taking into account external factors such as demographic information (e.g., gender, race or nationality) of the person from whom the biometrics images originated. Alternatively, the individual results could be returned to an external application or system where the results may be combined by whatever method or used individually to make a decision pertaining to the identification or verification of an individual.

Another method for implementing the identity verification system comprises the steps of: (a) accepting a request for biometrics identification or verification from an external third-party system such as an access control system, such request being transmitted via software communications protocols from the external third-party system to the central processing unit over an Ethernet network, and containing within such request both a unique identifier linked to the identity of the person who has requested access to a building, and a location identifier identifying which biometrics capture and/or processing device needs to be activated in order to perform the identity verification; (b) processing such request by: (1) retrieving an image or set of images in digital image file form, or, retrieving a set of digital data from the relevant biometrics capture and/or processing device or devices over a computer network via the video communication control device (in the event of an analogue output device), or via the digital data conversion engine (in the event of a digital output device), as identified by the location identifier; (2) sending such image or images, or digital data, to the relevant biometrics processing algorithm engine(s), such engine(s) being identified by the application residing on the central processing unit; (3) retrieving the results of such processing from the algorithm engine(s) in the form of a biometrics template (if not previously already created by the biometrics capture and/or processing device); (4) retrieving the previously stored templates linked to that person's identifier from the database; (5) sending the previously stored template and the newly acquired template to the relevant verification algorithm engine(s) for comparison and matching; (6) retrieving such results from the algorithm engine(s); and (7) transmitting such results back to the requesting third-party system over a computer network.

Advantages of the Identity Verification System

The identity verification system of the present invention provides at least the following advantages over existing systems:
(1) standard analog or digital cameras and standard biometrics sensors and/or devices can be used in the system;
(2) multiple cameras and/or biometrics sensors/devices can be connected to the processing computer or computer network, eliminating the use of a separate CPC at each verification point for final processing of images and biometrics data;
(3) the collection of biometrics related images and data are physically separated from the biometrics processing and analyzing system making the results less subject to subterfuge by a local user of the identity verification system;
(4) cameras and biometrics sensors/devices can be interchanged after installation, at the installed site on a “plug and play” basis without changing or upgrading the software on the processing computer 25, thereby ensuring that the system can always benefit from the latest technology enhancements;
(5) all supported biometrics devices/sensors communicate in exactly the same manner with the processing computer and are routed to the appropriate biometrics processing system, reference database, algorithm, and/or device driver ensuring that the software residing on the processing computer need not be changed or upgraded if a biometrics device or sensor is interchanged with another at any time;
(6) the performance of the identification verification system does not decrease when more biometrics capture devices are used at a verification point since the majority of processing pertaining to the identity verification system is performed on the processing computer network; and
(7) all communications over the computer network between any and all of the biometrics capture devices may be encrypted using standard and commonly used encryption systems.

While the foregoing description includes sufficient detail to enable those skilled in the art to practice the invention, it should be recognized that the description is illustrative in nature and that the invention is not limited in its application to the details of construction and the arrangement of components set forth in the description or illustrated in the drawings. The invention is capable of many modifications and variations that will be apparent to those skilled in the art having the benefit of these teachings. Also, it is to be understood that the phraseology and terminology employed herein is for the purposes of description and should not be regarded as limiting.

1. An identity recognition system comprising:
a plurality of biometrics input devices, wherein each device captures an image or a data file representing a unique biometrics characteristic of an individual;
a plurality of communication control devices, wherein one communication control device front-end prepares the image or the data file captured from one biometrics input device;
a central processing computer for processing the front-end-prepared image or data file to determine the identity of the individual, and
a hub for communicating information between the central processing computer and the communication control devices.

2. The system of claim 1, wherein at least one biometrics input device is an analogue output biometrics capture device.

3. The system of claim 2, wherein the analogue output biometrics capture device is a camera.

4. The system of claim 1, wherein at least one biometrics input device is a digital output biometrics capture device.

5. The system of claim 4 having at least one an analogue output biometrics capture device.

6. The system of claim 1, wherein the central processing computer is in communication with at least one biometrics processing system, at least one device driver, and at least one reference database.

7. The system of claim 6, wherein the biometrics processing system comprises an algorithm, and a biometrics processing software.

8. The system of claim 1, wherein the biometrics input device can be interchanged on a plug and play basis without requiring a reconfiguration of the system.

9. The system of claim 1, further comprising a visual output device.

10. The system of claim 9, wherein the visual output device is a liquid crystal display device.

11. An identity verification system, the verification system comprising:
(a) a processing computer;
(b) an analogue output biometrics capture device;
(c) a video communication control device in communication with the analogue output biometrics capture device;
(d) a digital output biometrics capture device;
(e) a digital data conversion device in communication with the digital output biometric capture device; and
(f) an Ethernet hub/switch in communication with the video communication control device, the digital data conversion device, and the processing computer.

12. The identity verification system of claim 11, wherein the processing computer communicates with the Ethernet hub/switch via a wireless connection.

13. The identity verification system of claim 11, wherein the processing computer has a plurality of biometrics processing systems.

14. The identity verification system of claim 13, wherein each biometrics processing system includes an algorithm and a processing software.

15. The identity verification system of claim 11, wherein the processing computer includes at least one biometrics processing system and at least one device driver.

16. The identity verification system of claim 11, wherein the analogue output biometric capture device is a camera, an optical fingerprint sensor, or an optical hand geometry reader.

17. The identity verification system of claim 11, wherein the video communication control device captures and processes an analogue image by compressing, digitizing and converting the analogue image into a common protocol for transmission over a computer network.

18. The identity verification system of claim 11, wherein the video communication control device comprises a video engine for capturing an image file and a transmitting engine for formatting the image file into a network based protocol.

19. The identity verification system of claim 18, wherein the video communication control device incorporates a location identifier into the image file.

20. The identity verification system of claim 11, wherein the digital data conversion device includes a communications engine to receive a digital data file from the digital output biometrics capture device, a conversion engine to convert the digital data file into a network based protocol, and a transmitting engine to enable the converted digital data file to be transmitted over a computer network.

21. The identity verification system of claim 11, wherein the Ethernet hub/switch is a multi-port hub.

22. The identity verification system of claim 21, wherein the Ethernet hub/switch has 4, 8 or 16 ports.

23. The identity verification system of claim 11 further comprising a display means for displaying information to a user.

24. A method for identifying an individual having unique biometrics characteristics, comprising the steps of:
capturing data at a verification point for at least one unique biometrics characteristic of the individual;
front-end-preparing the captured data for transmission;
transmitting the front-end prepared data over an Internet-Protocol based network to a central processing computer for processing;
processing the transmitted data in the central processing computer to determine the identity of the individual; and
communicating to the verification point the outcome of the identity determination.

25. The method of claim 24, wherein the capturing and front-end-preparing steps further comprise the steps of:
acquiring a live video stream of the individual taken with a camera at the verification point, wherein the video stream comprises a plurality of photographic image frames,
selecting at least one photographic image frame from the plurality of frames, and
converting the selected photographic image frame into at least one compressed, digitized image and adding the image to the front-end prepared data for transmitting.

26. The method of claim 24, wherein the capturing and front-end preparing steps further comprise the steps of:
acquiring biometrics-related data from at least one biometrics input device, and
front-end processing the captured data by compressing and converting the data to a standard protocol format for transmitting.

27. The method of claim 24, wherein the capturing and front-end preparing steps further comprise the steps of:
acquiring biometrics-related data from at least one biometrics input device;
acquiring a live video stream of the individual taken with a camera at the verification point, wherein the video stream comprises a plurality of photographic image frames;
front-end preparing the captured biometrics-related data by compressing and converting the data to a standard protocol format for transmitting; and
front-end processing the captured video stream by selecting at least one photographic image frame from the plurality of frames, and converting the selected photographic image frame into at least one compressed, digitized image and adding the image to the front-end-prepared data for transmitting.

28. The method of claim 24, wherein the processing step further comprises the step of comparing the transmitted data to a library of biometrics data for known individuals to find a match of biometrics data and thereby identifying the individual.

29. The method of claim 24, wherein the processing step further comprises the step of verifying that the transmitted data for the individual to be identified matches the biometrics data for the specific person that the individual claims to be.

30. The method of claim 24, wherein the capturing and processing steps further comprise the steps of:
gathering the biometrics characteristics data from at least one biometrics input device, and customizing the analysis of the transmitted biometrics data based on information contained in a reference database for the specific biometrics input device.

31. The method of claim 24, wherein the front-end-processing step further comprises encrypting the front-end-prepared data before transmitting.

32. A method of identifying an individual having unique biometrics characteristics, comprising the steps of:
acquiring a live video stream of the individual taken with at least one camera, wherein the video stream comprises a plurality of photographic image frames;
acquiring biometrics-related data from at least one biometrics sensor/device;
acquiring input data from at least one data input device;
selecting at least one photographic image frame from the plurality of frames;
front-end-preparing the selected photographic image frame by converting the selected frame into at least one compressed, digitized image;
front-end-preparing the biometrics-related data for transmission by compressing and converting the data to a standard protocol format for transmitting;
front-end-preparing the input data by compressing and converting the data into a standard network-based protocol;
transmitting the front-end prepared image, front-end prepared biometrics data, front-end prepared input data and a header for identifying the origins of the image or data to a central processing computer via an Internet-Protocol based network;
processing the front-end prepared image and data at the central processing computer to determine the identity of the individual; and
providing feedback on the processing to the location identified in the header.

33. A method of combining data and images from a plurality of biometric sensors, data input devices and cameras to determine the identity of an individual, comprising the steps of:
capturing biometrics-related data and images and other input data from a plurality of biometrics sensors/devices, data input devices and cameras,
converting the biometrics-related data, images and input data to a format that can be communicated using a standard network-based protocol,
transmitting the converted data and images with a header containing origin information over an Internet-Protocol-based network to a central processing computer,
processing the converted data and images at the central processing computer to determine the identity of the individual,
activating connected devices as determined by the result of the processing; and
communicating the result of the processing to the location identified in the header.

34. A method of adding biometrics information of an individual to a biometrics database in a central processing computer from a remote terminal, comprising the steps of:
capturing data at the remote terminal for at least one unique biometrics characteristic of the individual,
front-end-preparing the captured data for transmission,
transmitting the front-end-prepared data over an Internet-Protocol-based network to a central processing computer for processing,
processing the transmitted data in the central processing computer to add the transmitted data to the biometrics database, and
communicating to the remote terminal the results of the processing.
